(19) United States
(12) Patent Application Publication
(10) Pub. No.: US 2014/0327698 A1
(43) Pub. Date: Nov. 6, 2014

(54) SYSTEM AND METHOD FOR HYBRID GRAPHICS AND TEXT RENDERING AND CLIENT COMPUTER AND GRAPHICS PROCESSING UNIT INCORPORATING THE SAME

(71) Applicant: NVIDIA CORPORATION, Santa Clara, CA (US)

(72) Inventors: Stefan Schoenefeld, Wurselen (DE); Ingo Esser, Wurselen (DE)

(73) Assignee: Nvidia Corporation, Santa Clara, CA (US)

(21) Appl. No.: 13/887,736

(22) Filed: May 6, 2013

(51) Int. Cl. G09G 5/377

(52) U.S. Cl. CPC G09G 5/377
USPC 345/629

(57) ABSTRACT

A client computer, a graphics processing unit (GPU) and a method for hybrid graphics and text rendering. One embodiment of the client computer operable to display a remotely rendered image includes: (1) a network interface controller (NIC) configured to receive the remotely rendered image and un-rendered text, (2) a processor configured to generate a text overlay from the un-rendered text, and (3) a display operable to display the remotely rendered image and the text overlay.

### TECHNICAL FIELD

This application is directed, in general, to remote rendering and, more specifically, to rendering text for remote clients.

### BACKGROUND

The utility of personal computing was originally focused at an enterprise level, putting powerful tools on the desktops of researchers, engineers, analysts and typists. That utility has evolved from mere number-crunching and word processing to highly programmable, interactive workpieces capable of production level and real-time graphics rendering for incredibly detailed computer aided design, drafting and visualization. Personal computing has more recently evolved into a key role as a media and gaming outlet, fueled by the development of mobile computing. Personal computing is no longer resigned to the world's desktops, or even laptops. Robust networks and the miniaturization of computing power have enabled mobile devices, such as cellular phones and tablet computers, to carve large swaths out of the personal computing market. Desktop computers remain the highest performing personal computers available and are suitable for traditional businesses, individuals and garners. However, as the utility of personal computing shifts from pure productivity to envelope media dissemination and gaming, and, more importantly, as media streaming and gaming form the leading edge of personal computing technology, a dichotomy develops between the processing demands for “everyday” computing and those for high-end gaming, or, more generally, for high-end graphics rendering.

The processing demands for high-end graphics rendering drive development of specialized hardware, such as graphics processing units (GPUs) and graphics processing systems (graphics cards). For many users, high-end graphics hardware would constitute a gross under-utilization of processing power. The rendering bandwidth of high-end graphics hardware is simply lost on traditional productivity applications and media streaming. Cloud graphics processing is a centralization of graphics rendering resources aimed at overcoming the developing misallocation.

In cloud architectures, similar to conventional media streaming, graphics content is stored, retrieved and rendered on a server where it is then encoded, packetized and transmitted over a network to a client as a video stream (often including audio). The client simply decodes the video stream and displays the content. High-end graphics hardware is thereby obviated on the client end, which requires only the ability to play video. Graphics processing servers centralize high-end graphics hardware, enabling the pooling of graphics rendering resources where they can be allocated appropriately upon demand. Furthermore, cloud architectures pool storage, security and maintenance resources, which provide users easier access to more up-to-date content than can be had on traditional personal computers.

Perhaps the most compelling aspect of cloud architectures is the inherent cross-platform compatibility. The corollary to centralizing graphics processing is offloading large complex rendering tasks from client platforms. Graphics rendering is often carried out on specialized hardware executing proprietary procedures that are optimized for specific platforms running specific operating systems. Cloud architectures need only a thin-client application that can be easily portable to a variety of client platforms. This flexibility on the client side lends itself to content and service providers who can now reach the complete spectrum of personal computing consumers operating under a variety of hardware and network conditions.

### SUMMARY

One aspect provides a client computer operable to display a remotely rendered image. In one embodiment, the computer includes: (1) a network interface controller (NIC) configured to receive the remotely rendered image and un-rendered text, (2) a processor configured to generate a text overlay from the un-rendered text, and (3) a display operable to display the remotely rendered image and the text overlay.

Another aspect provides a method of remotely rendering an image containing text. In one embodiment, the method includes: (1) recognizing and withholding the text from image rendering, (2) rendering the image to yield a rendered image, (3) transmitting the rendered image to a client for display, and (4) transmitting text data, text format data and text visibility data toward the client for later rendering of the text as an overlay to the rendered image.

Yet another aspect provides a GPU operable to render an image. In one embodiment, the GPU includes: (1) a text filter configured to recognize and withhold text within the image from rendering, and (2) a graphics renderer operable to render the image into an image frame that lacks the text.

### BRIEF DESCRIPTION

Reference is now made to the following descriptions taken in conjunction with the accompanying drawings, in which:

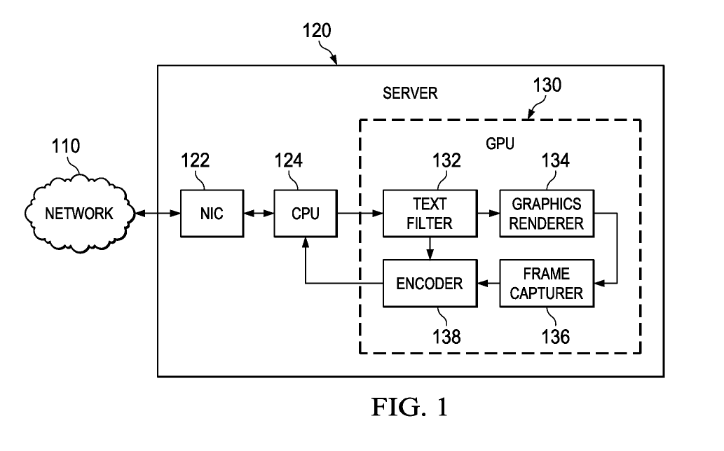

FIG. 1 is a block diagram of one embodiment of a graphics server;

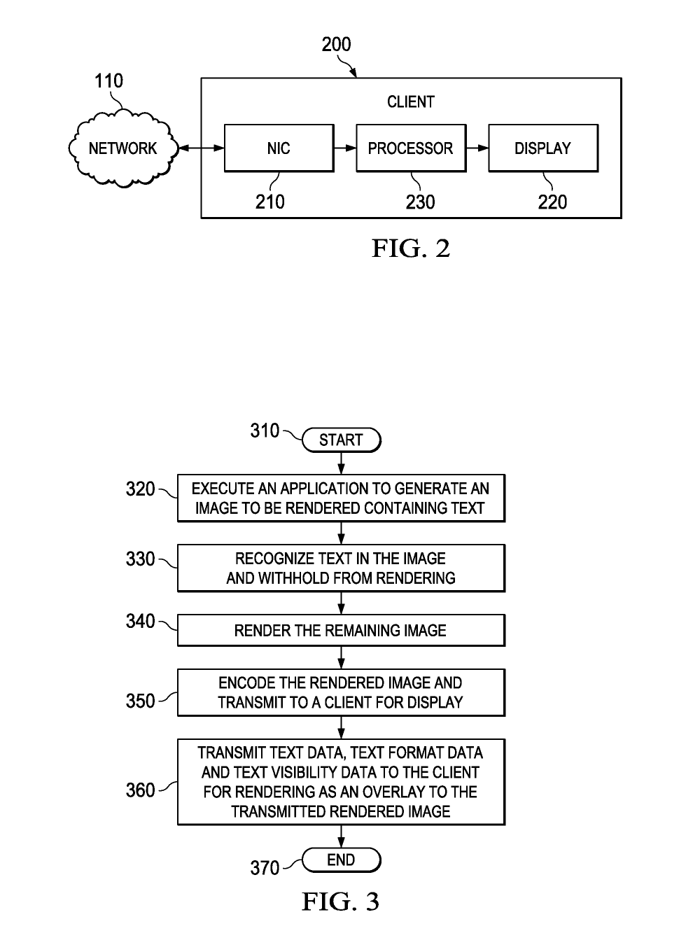

FIG. 2 is a block diagram of one embodiment of a client computer; and

FIG. 3 is a flow diagram of one embodiment of a method of remotely rendering an image containing text.

### DETAILED DESCRIPTION

Remote rendering in cloud architectures often encounter text in the images to be rendered. This is common while “remoting” a desktop, but is not limited to that circumstance. For example, a word processing application can generate very dense text to be rendered. Other, more graphics intensive applications, such as games, also call for text rendering in menus, prompts, instructions and story boards, among other instances. Once the images are rendered, they are typically encoded or undergo compression before being transmitted to the client. Compression can be lossy and results in the quality of displayed text being degraded in the images displayed by the client. A high level of detail, and therefore a large amount of transferred date, would be required to maintain a high quality in remotely rendered text.

It is realized herein that text can be withheld from rendering on the server and can then be rendered on the client. It is further realized herein the server can capture the text from an image to be rendered, and transfer it to the client. The text includes text data itself, along with text formatting data and visibility data. The server renders the remainder of the image and transmits it to the client. It is also realized that the encoded image can be smaller having removed the details necessary for rendered text. The client can use rendering functions built into its operating system (OS) to render the text as an overlay to the encoded rendered image.

FIG. 1 is a block diagram of a graphics server 120 coupled to a network 110. Server 120 represents the central repository of gaming content, processing and rendering resources. Clients are a consumer of that content and those resources. Server 120 communicates to various clients via network 110 and is freely scalable and has the capacity to provide that content and those services to many clients simultaneously by leveraging parallel and apportioned processing and rendering resources.

Server 120 includes a network interface card (NIC) 122, a central processing unit (CPU) 124 and a GPU 130. Upon request from a client, graphics content is recalled from memory via an application executing on CPU 124. As is convention for graphics applications, games for instance, CPU 124 reserves itself for carrying out high-level operations, such as determining position, motion and collision of objects in a given scene. From these high level operations, CPU 124 generates rendering commands that, when combined with the scene data, can be carried out by GPU 130. For example, rendering commands and data can define scene geometry, lighting, shading, texturing, motion, and camera parameters for a scene. Graphics content can also include text.

GPU 130 includes a text filter 132, a graphics renderer 134, a frame capturer 136 and an encoder 138. Text filter 132 recognizes any text embedded in a scene and withholds it from subsequent rendering procedures. Graphics renderer 134 executes rendering procedures according to the rendering commands generated by CPU 124, yielding a stream of frames of video for the scene. Those raw video frames, lacking the withheld text, are captured by frame capturer 136 and encoded by encoder 138. Encoder 136 formats the raw video stream for transmission, possibly employing a video compression algorithm such as the H.264 standard arrived at by the International Telecommunication Union Telecommunication (ITU-T) Standardization Sector or the MPEG-4 Advanced Video Coding (AVC) standard from the International Organization for Standardization/International Electrotechnical Commission (ISO/IEC). Alternatively, the video stream may be encoded into Windows Media Video® (WMV) format, VP8 format, or any other video encoding format.

The text withheld from rendering includes a variety of data necessary for rendering, including: the text data itself, text format data and text visibility data. The text can be encoded along with the rendered image, as is shown in FIG. 1. Alternatively, the text can be passed directly to CPU 124.

CPU 124 prepares the encoded video stream and text for transmission, which is passed along to NIC 122. NIC 122 includes circuitry necessary for communicating over network 110 via a networking protocol such as Ethernet, Wi-Fi or Internet Protocol (IP). NIC 122 provides the physical layer and the basis for the software layer of the network interface of server 120.

FIG. 2 is a block diagram of one embodiment of a client device 200 coupled to network 110 of FIG. 1. Client 200 includes a NIC 210, a display 220 and a processor 230. Client 200 receives a transmitted video stream for display, along with transmitted un-rendered text. Client 200 can be a variety of personal computing devices, including: a desktop or laptop personal computer, a tablet, a Smartphone or a television. NIC 210, similar to NIC 122 of FIG. 1, includes circuitry necessary for communicating over network 110 and provides the physical layer and the basis for the software layer of client 200's network interface. The transmitted video stream and text are received by client 200 through NIC 210. The video stream is then decoded. The decoder used should match the encoder on the server, in that each should employ the same formatting or compression scheme. For instance, if the server's encoder employs the ITU-T H.264 standard, so should the client decoder. Decoding may be carried out by either a client CPU or a client GPU, depending on the physical client device. Once decoded, all that remains in the video stream are the raw rendered frames.

Processor 230 executes an operating system on which client 200 is based. Operating systems typically include functionality to carry out basic rendering functions, including those necessary for text. Processor 230 renders the transmitted un-rendered text as an overlay for the raw rendered frames. The composite rendered video and text can then be displayed on display 220.

FIG. 3 is a flow diagram of one embodiment of a method of remotely rendering an image containing text. The method begins in a start step 310. In a step 320 an application is executed, typically on a server by a CPU, that generates an image to be rendered than contains text. In a filtering step 330, the text in the image is recognized and withheld from rendering. The remaining image is rendered in a step 340. By not rendering the text on the server, the text does not undergo lossy compression that degrades the quality of displayed text, and it reduces the size of the compressed image, as it contains fewer details.

The rendered image is encoded and transmitted to a client for display in a step 350. The text, which includes text data, text format data and text visibility data, is transmitted to the client in a step 360. In certain embodiments, the client receives both the encoded rendered image and the text. The client would then render the text as an overlay to the rendered image, which is then displayed. The method then ends in a step 370.

Those skilled in the art to which this application relates will appreciate that other and further additions, deletions, substitutions and modifications may be made to the described embodiments.

What is claimed is:

1. A client computer operable to display a remotely rendered image, comprising:
a network interface controller (NIC) configured to receive said remotely rendered image and un-rendered text;
a processor configured to generate a text overlay from said un-rendered text; and
a display operable to display said remotely rendered image and said text overlay.

2. The client computer recited in claim 1 wherein said un-rendered text includes text data, text format data and text visibility data.

3. The client computer recited in claim 1 wherein said remotely rendered image is encoded and said client computer further comprises a decoder configured to decode said rendered image for display.

4. The client computer recited in claim 1 wherein said processor is further configured to execute an operating system (OS) operable to render said text overlay.

5. The client computer recited in claim 1 wherein said processor is a central processing unit (CPU).

6. The client computer recited in claim 1 wherein said remotely rendered image initially contained said un-rendered text.

7. The client computer recited in claim 6 wherein said un-rendered text is withheld from previous rendering of said remotely rendered image.

8. A method of remotely rendering an image containing text, comprising:
recognizing and withholding said text from image rendering;
rendering said image to yield a rendered image;
transmitting said rendered image to a client for display; and
transmitting text data, text format data and text visibility data toward said client for later rendering of said text as an overlay to said rendered image.

9. The method recited in claim 8 wherein said text format data includes text font, text size and text location.

10. The method recited in claim 8 further comprising encoding said rendered image before said transmitting.

11. The method recited in claim 10 wherein said encoding includes applying H.264 compression.

12. The method recited in claim 8 further comprising employing an operating system (OS) on said client to generate rendered text from said text, said format data and said text visibility data.

13. The method recited in claim 12 further comprising receiving and displaying said rendered image and displaying said rendered text as an overlay to said rendered image.

14. The method recited in claim 8 further comprising executing an application, thereby generating said image and text.

15. A graphics processing unit (GPU) operable to render an image, comprising:
a text filter configured to recognize and withhold text within said image; and
a graphics renderer operable to render said image into an image frame that lacks said text.

16. The GPU recited in claim 15 further comprising an encoder operable to encode said image frame for subsequent transmission to a client.

17. The GPU recited in claim 15 further comprising a frame capturer operable to capture a sequence of image frames over time.

18. The GPU recited in claim 15 wherein said text includes text data, text format data and text visibility data.

19. The GPU recited in claim 18 wherein said GPU is coupled to a network interface controller (NIC) operable to transmit said image frame and said text to a client.

20. The GPU recited in claim 19 wherein said client is configured to display said image frame and render said text as an overlay to said image frame.
